(19) United States
(12) Patent Application Publication
(10) Pub. No.: US 2026/0050455 A1
(43) Pub. Date: Feb. 19, 2026

(54) INFORMATION PROCESSING METHOD AND APPARATUS, AND ELECTRONIC DEVICE

(71) Applicant: BEIJING ZITIAO NETWORK TECHNOLOGY CO., LTD, Beijing (CN)

(72) Inventors: Fangjia CHEN, Beijing (CN); Yihan FANG, Beijing (CN); Gang XIN, Beijing (CN)

(21) Appl. No.: 19/104,032

(22) PCT Filed: Nov. 20, 2023
(86) PCT No.: PCT/CN2023/132633

§ 371 Date: Feb. 14, 2025

(30) Foreign Application Priority Data
Nov. 24, 2022 (CN) 202211484448.6

(51) Int. Cl. G06F 9/451; G06F 3/04842

(52) U.S. Cl. CPC G06F 9/451; G06F 3/04842

(57) ABSTRACT

Disclosed in embodiments of the present disclosure are an information processing method and apparatus, and an electronic device. The information processing method includes: in response to receiving a preset operation instruction relating to a target session, displaying an interaction interface corresponding to the target session; displaying at least one guide control in the interaction interface; and in response to receiving a trigger operation relating to a target guide control among the at least one guide control, performing a processing operation corresponding to the trigger operation.

### CROSS-REFERENCE TO RELATED APPLICATION(S)

The present disclosure claims priority to Chinese Patent Application No. 202211484448.6, filed on Nov. 24, 2022, entitled “INFORMATION PROCESSING METHOD AND APPARATUS, AND ELECTRONIC DEVICE”, which is incorporated herein by reference in its entirety.

### TECHNICAL FIELD

The present disclosure relates to the field of Internet technologies, and in particular to an information processing method and apparatus, and an electronic device.

### BACKGROUND

With the development of computer and Internet technologies, users may exchange information through applications provided in electronic terminals. For example, a user may exchange information with a plurality of contacts through a communication application, and a client interface of the application may display information of chats with the plurality of contacts.

### SUMMARY

This Summary is provided to introduce concepts in a simplified form that are described in detail in the following Detailed Description section. This Summary section is not intended to identify key features or essential features of the claimed technical solution, nor is it intended to be used to limit the scope of the claimed technical solution.

In a first aspect, an embodiment of the present disclosure provides an information processing method, including: displaying an interactive interface corresponding to a target chat in response to receipt of a preset operation instruction for the target chat, wherein at least one guide control is displayed in the interactive interface; and performing a processing operation corresponding to a trigger operation in response to receipt of the trigger operation for a target guide control of the at least one guide control.

In a second aspect, an embodiment of the present disclosure provides an information processing apparatus, including: a displaying unit configured to display an interactive interface corresponding to a target chat in response to receipt of a preset operation instruction for the target chat, wherein at least one guide control is displayed in the interactive interface; and a processing unit configured to perform a processing operation corresponding to a trigger operation in response to receipt of the trigger operation for a target guide control of the at least one guide control.

In a third aspect, an embodiment of the present disclosure provides an electronic device, including: one or more processors; and a storage configured to store one or more programs, wherein the one or more programs, when executed by the one or more processors, cause the one or more processors to implement the information processing method according to the first aspect.

In a fourth aspect, an embodiment of the present disclosure provides a non-transitory computer-readable medium having a computer program stored thereon, wherein the computer program, when executed by a processor, implements the information processing method according to the first aspect.

In a fifth aspect, an embodiment of the present disclosure provides a computer program, wherein the computer program, when executed by a processor, implements the information processing method according to the first aspect.

### BRIEF DESCRIPTION OF THE DRAWINGS

The above and other features, advantages and aspects of various embodiments of the present disclosure will become more apparent with reference to the following detailed description in conjunction with the drawings. Throughout the drawings, the same or similar reference numerals denote the same or similar elements. It should be understood that the drawings are schematic and that parts and elements are not necessarily drawn to scale.

FIG. 1 is a flowchart of an embodiment of an information processing method according to the present disclosure;

FIGS. 2A-2B are schematic diagrams of an application scenario of the information processing method according to the present disclosure;

FIGS. 3A-3B are schematic diagrams of another application scenario of the information processing method according to the present disclosure;

FIGS. 4A-4B are schematic diagrams of another application scenario of the information processing method according to the present disclosure;

FIG. 5 is a schematic diagram of another application scenario of the information processing method according to the present disclosure;

FIGS. 6A-6B are schematic diagrams of another application scenario of the information processing method according to the present disclosure;

FIGS. 7A-7B are schematic diagrams of another application scenario of the information processing method according to the present disclosure;

FIG. 8 is a schematic structural diagram of an embodiment of an information processing apparatus according to the present disclosure;

FIG. 9 is an exemplary system architecture to which an embodiment of an information processing method according to the present disclosure may be applied; and FIG. 10 is a schematic diagram of a basic structure of an electronic device provided according to an embodiment of the present disclosure.

### DETAILED DESCRIPTION OF EMBODIMENTS

Embodiments of the present disclosure will be described in more detail below with reference to the drawings. While certain embodiments of the present disclosure are shown in the drawings, it should be understood that the present disclosure may be implemented in various forms, and should not be construed as limited to the embodiments set forth herein. Rather, these embodiments are provided for a thorough and complete understanding of the present disclosure. It should be understood that the drawings and the embodiments of the present disclosure are only for illustrative purposes, and are not intended to limit the scope of protection of the present disclosure.

It should be understood that the various steps described in the method implementations of the present disclosure may be performed in different orders and/or in parallel. Furthermore, the method implementations may include additional steps and/or omit performing the illustrated steps. The scope of the present disclosure is not limited in this respect.

The term “include/comprise” and its variations as used herein are open-ended inclusions, i.e., “include/comprise but not limited to”. The term “based on” is “at least partially based on”. The term “an embodiment” means “at least one embodiment”; the term “another embodiment” means “at least one another embodiment”; and the term “some embodiments” means “at least some embodiments”. Relevant definitions of other terms will be given in the description below.

It should be noted that the concepts of “first”, “second”, etc. mentioned in the present disclosure are only used to distinguish different apparatuses, modules, or units, and are not used to limit the order of functions performed by these apparatuses, modules, or units or their interdependence.

It should be noted that the modifiers “a”, “an”, “one”, or “multiple” mentioned in the present disclosure are illustrative and not restrictive, and those skilled in the art should understand that they should be understood as “one or more”unless the context clearly indicates otherwise.

The names of messages or information exchanged between multiple apparatuses in the implementations of the present disclosure are only for illustrative purposes, and are not intended to limit the scope of these messages or information.

Embodiments of the present disclosure provide an information processing method and apparatus, and an electronic device, where a guide control may be displayed to a user, so as to assist the user in processing and using information based on the guide control, thereby improving the user's interaction experience.

In the information processing method and apparatus, and the electronic device provided by the embodiments of the present disclosure, an interactive interface corresponding to a target chat is displayed in response to receipt of a preset operation instruction for the target chat, where at least one guide control is displayed in the interactive interface; and a processing operation corresponding to a trigger operation is performed in response to receipt of the trigger operation for a target guide control of the at least one guide control. Therefore, for the user, after the preset operation instruction is issued, a corresponding processing operation may be initiated through the trigger operation for the at least one guide control. In one aspect, the at least one guide control serves as a guide and reminder, so as to assist the user in better processing and using the related information. In another aspect, the processing operation corresponding to the trigger operation may be performed through the trigger operation for the at least one guide control, so as to achieve a rapid response to the user's needs. Thus, the technical solution may not only assist the user in better processing and using information, but also quickly respond to the user's needs for processing and use, thereby improving the user's interaction experience.

The information processing solution provided in the implementations of the present disclosure may be applied to information exchange scenarios of computer and Internet. In these information exchange scenarios, a user exchanges information with a contact through a corresponding communication application (e.g., an instant messaging application or an office suite application including an instant messaging function).

In some application scenarios, the information exchange is group chat exchange, that is, a plurality of users may exchange information in a group chat. In some other application scenarios, the information exchange is individual chat exchange, that is, two users interact through an individual chat.

In the group chat exchange scenario, due to different types of group chats, there are differences in information processing manners of users in different group chat types; and due to different roles of different users in the group chat, there are differences in information processing manners of different users.

In the individual chat scenario, due to different configuration manners of the individual chat by different users, there are differences in information processing manners of different users.

In the related art, in the information exchange scenario, there are differences in information processing manners for different users or different chats. Therefore, for the user, the user does not know which information processing functions are available, nor does the user know which information processing functions are provided in the chat, resulting in poor processing of such information by the user.

Based on this, the implementations of the present disclosure provide an information processing solution. In the information processing solution, compared with the related art, at least one guide control is newly added in an interactive interface of a chat to guide the user to better use and process information. In one aspect, the at least one guide control serves as a guide and reminder, so as to assist the user in better processing and using the related information. In another aspect, the processing operation corresponding to the trigger operation may be performed through the trigger operation for the at least one guide control, so as to achieve a rapid response to the user's needs. Thus, the technical solution may not only assist the user in better processing and using information, but also quickly respond to the user's needs for processing and use, thereby improving the user's interaction experience.

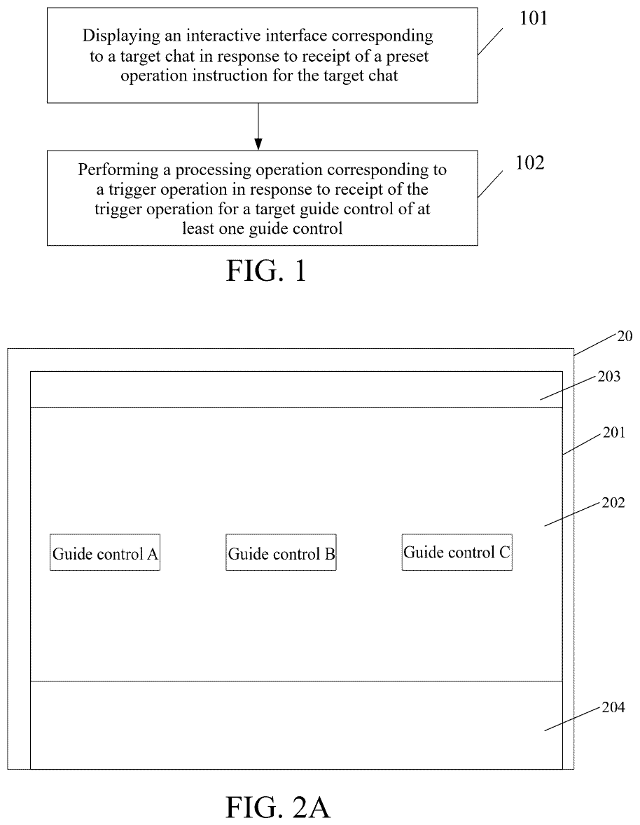

Referring to FIG. 1, it shows the flow of an embodiment of an information processing method according to the present disclosure. The information processing method may be applied to a terminal device. As shown in FIG. 1, the information processing method includes the following steps:
Step 101, displaying an interactive interface corresponding to a target chat in response to receipt of a preset operation instruction for the target chat. At least one guide control is displayed in the interactive interface.

In the implementations of the present disclosure, the guide control may be a control for inviting a member to join the chat, a control for perfecting chat information, a control for perfecting a chat announcement, a control for configuring a chat label, or the like.

In some embodiments, the target chat is a designated chat in a chat application. A terminal device corresponding to the chat application may be a computer terminal or a mobile terminal. For different terminal devices, information may be displayed in different forms in the chat application.

In some embodiments, the target chat is an individual chat. In some other embodiments, the target chat is a group chat. With regard to the individual chat, the chat type involved therein may be a normal individual chat, a special individual chat (e.g., an encrypted/private individual chat), or the like. The encrypted/private individual chat may be a chat that can be opened only after identity (password) authentication. Different individual chat types have different information processing functions. For example, the special individual chat may require information encryption mode or the like to be set.

With regard to the group chat, the chat types involved therein are relatively rich, for example, a public group, a private group, an all-member group, a department group, and the like. Moreover, different chat types of group chats may affect information processing functions of the group chats. For example, a public group does not limit group membership, while a private group does. Therefore, compared with a public group chat, a private group may have more information processing functions.

Therefore, the chat type of the target chat may determine the type of guide control displayed in the interactive interface.

Therefore, in some embodiments, the type of guide control is related to the chat type of the target chat. Thus, when the chat types of the target chats are different, the guide controls displayed in the interactive interfaces are different.

In addition, the concept of user role is involved in the group chat, such as a group owner, a group administrator, an ordinary group member, etc.; when the user roles are different, the corresponding information processing functions are also different. For example, a group owner and a group administrator may arbitrarily invite group members to join the group, but an ordinary group member cannot arbitrarily invite group members to join the group.

Therefore, the role played by the user in the target chat may also determine the type of guide control.

Therefore, in some other embodiments, the type of guide control is also related to the role played by the user to which the interactive interface belongs in the target chat. Thus, when the roles played by the user in the target chat are different, the guide controls displayed in the interactive interface are different.

In the embodiments of the present disclosure, the guide control may be understood as a control that guides the user to perform an information processing function. The guide control may serve as a reminder for some information processing functions, and the user may quickly trigger these information processing functions through the guide control.

In some embodiments, displaying the at least one guide control in the interactive interface includes: displaying the at least one guide control in a chat message display area of the interactive interface.

In this implementation, the interactive interface corresponding to the target chat includes multiple areas, such as a basic information display area of the target chat, where the display area is used to display basic information such as a name, an avatar (or profile picture), and some basic function controls of the target chat. If the guide control is displayed in this section, it may affect the display of such basic information.

The chat message display area is used to display messages corresponding to the target chat, and the area of this display area is relatively large. Displaying the at least one guide control herein will not affect other display content, and the display effect is more apparent, which is convenient for the user to see the guide control.

In some embodiments, the chat message display area may be divided into two parts, one part is used to display a current chat message, and the other part is used to display the at least one guide control. For example, the at least one guide control is displayed in an upper half of the chat message display area, and the current chat message is displayed in a lower half of the chat message display area.

In some embodiments, a display position of the at least one guide control in the chat message display area and a size of the at least one guide control may be determined based on a size of the chat message display area and a number of the at least one guide control.

In some embodiments, a spacing may be provided between display positions of multiple guide controls, and the size of the spacing also depends on the size of the chat message display area and the number of the multiple guide controls.

In some other embodiments, the size of the chat message display area is adjustable, and after the size of the chat message display area is adjusted, the size and the display position of the at least one guide control may also change accordingly.

In some embodiments, the guide control may be displayed in a card, and the shape and size of the card may be configured in conjunction with different application scenarios.

In some other embodiments, in addition to the guide control, a picture or text corresponding to the guide control may also be displayed in the card. The form of the corresponding picture or text may be determined by the information processing function corresponding to the guide control.

In some embodiments, the arrangement of the multiple guide controls may be from top to bottom, from left to right, etc. Moreover, as the size of the chat message display area changes, the arrangement of the multiple guide controls may change accordingly. For example, when the size of the chat message display area is relatively large, the multiple guide controls are arranged from left to right; when the size of the chat message display area is relatively small, the multiple guide controls are arranged from top to bottom.

In some embodiments, the preset operation instruction includes: a creation operation instruction for the target chat; and a chat type conversion operation instruction for the target chat.

In some embodiments, after a user inputs target chat information such as a name, an avatar, and a group member of the target chat, the user determines to create the target chat, which is regarded as initiating the creation operation instruction for the target chat. At this time, a chat application may complete the creation of the target chat based on such target chat information, and display the interactive interface of the target chat.

In some other embodiments, after a user converts a chat type of the target chat from a current chat type to another chat type, it is regarded as initiating the chat type conversion operation instruction. At this time, the chat application updates the chat type of the target chat based on the converted chat type, and displays the interactive interface of the target chat.

As an optional implementation, displaying the interactive interface corresponding to the target chat includes: displaying the interactive interface corresponding to the target chat according to at least one guide control corresponding to the target chat delivered by a server.

In this implementation, the at least one guide control corresponding to the target chat is delivered by the server, that is, the server determines which guide controls need to be included in the interactive interface corresponding to the target chat.

As an optional implementation, the server delivers the at least one guide control corresponding to the target chat according to the chat type of the target chat and/or the role played by the user to which the interactive interface belongs in the target chat.

In this implementation, since the type of the at least one guide control may be determined by the chat type of the target chat and/or the role played by the user to which the interactive interface belongs in the target chat, the server may also deliver the at least one guide control according to the chat type of the target chat and/or the role played by the user to which the interactive interface belongs in the target chat.

For example, assuming that the role played by the user in the target chat is the group owner, the guide control includes a control for inviting a member to join the chat; assuming that the role played by the user in the target chat is an ordinary member, the guide control does not include the control for inviting a member to join the chat.

For another example, assuming that the chat type of the target chat is a private group chat, the guide control includes a control for configuring a chat label; assuming that the chat type of the target chat is a public group chat, the guide control does not include the control for configuring a chat label.

In some other embodiments, whether the at least one guide control is delivered by the server or in other manners, the at least one guide control displayed in the interactive interfaces corresponding to different chats may be the same. However, if this implementation is adopted, it is necessary to configure the usage permission of the at least one guide control in conjunction with the chat type of the target chat and/or the role played by the user in the target chat. The trigger operation can be performed for the guide control only when the target chat has the usage permission and/or the user has the usage permission; and the trigger operation cannot be performed for the guide control when the target chat does not have the usage permission and/or the user does not have the usage permission.

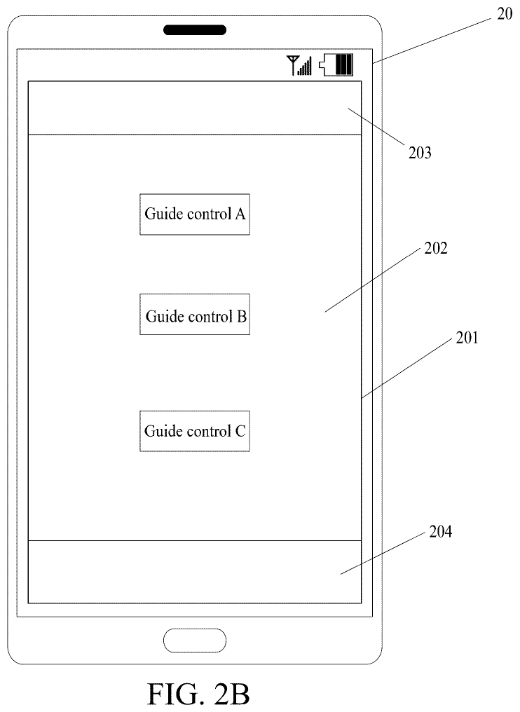

As shown in FIG. 2A, an interactive interface 201 corresponding to a target chat is displayed on a client display interface 20, and the interactive interface 201 includes a chat message display area 202, a chat information display area 203 and a chat message input area 204; where the interactive interface 201 is understood as a display area composed of the chat message display area 202, the chat information display area 203 and the chat message input area 204. In the chat message display area 202, a guide control A, a guide control B and a guide control C are displayed. The guide control A, the guide control B and the guide control C are displayed in a card, and the guide control A, the guide control B and the guide control C are arranged from left to right in the chat message display area 202. It should be noted that in some embodiments, in addition to the interactive interface 201 corresponding to the target chat, the client display interface 20 may also include other display content, such as a feed; FIG. 2A is only an example of a client display interface, and the purpose is to illustrate the interactive interface 201 of the target chat, so other possible display content is not shown.

As shown in FIG. 2B, an interactive interface 201 corresponding to a target chat is displayed on a client display interface 20, and the interactive interface 201 includes a chat message display area 202, a chat information display area 203 and a chat message input area 204; where the interactive interface 201 is understood as a display area composed of the chat message display area 202, the chat information display area 203 and the chat message input area 204. In the chat message display area 202, a guide control A, a guide control B and a guide control C are displayed. The guide control A, the guide control B and the guide control C are displayed in a card, and the guide control A, the guide control B and the guide control C are arranged from top to bottom in the chat message display area 202.

As an optional implementation, at least one piece of guidance information is further displayed in the interactive interface, and the guidance information is related to a chat type of the target chat.

In some embodiments, the guidance information includes guidance information corresponding to at least one guide control, and at this time, the guidance information may be a name of the guide control. For example, for the control for inviting a member to join the chat, the corresponding guidance information is: invite a member; for the control for perfecting chat information, the corresponding guidance information is: perfect chat information.

In this implementation, since the guidance information corresponds to the guide control, and the guide control is related to the chat type of the target chat, the guidance information is also related to the chat type of the target chat.

In some other embodiments, the guidance information includes prompt information corresponding to the preset operation instruction.

In some embodiments, if the preset operation is the creation operation instruction for the target chat, the guidance information may include: “Welcome to join the XX chat”, “XX invites XXX to join the chat”, etc.

In some embodiments, if the preset operation is the chat type conversion operation instruction for the target chat, the guidance information may include: “Chat type conversion is successful”, “XX invites XXX to join the chat”, etc.

In some other embodiments, other guidance information may also be configured in conjunction with different chat types, which is not limited herein.

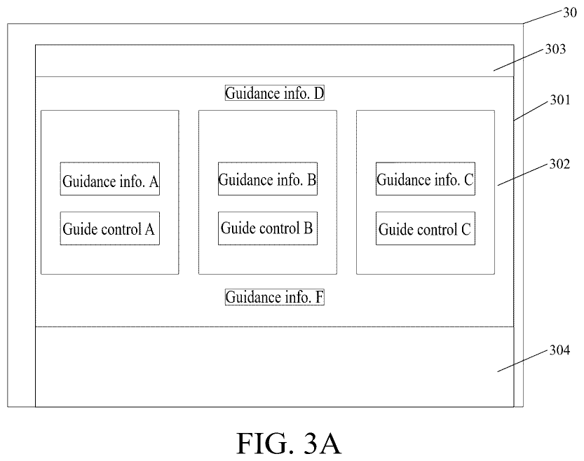

As shown in FIG. 3A, an interactive interface 301 corresponding to a target chat is displayed on a client display interface 30, and the interactive interface 301 includes a chat message display area 302, a chat information display area 303 and a chat message input area 304; where the interactive interface 301 is understood as a display area composed of the chat message display area 302, the chat information display area 303 and the chat message input area 304. In the chat message display area 302, a guide control A, a guide control B and a guide control C are displayed. The guide control A, the guide control B and the guide control C are displayed in cards. Moreover, in the chat message display area 302, guidance information A corresponding to the guide control A, guidance information B corresponding to the guide control B, and guidance control C corresponding to the guide control C, as well as guidance information D and guidance information F are further displayed; and the guidance information D and the guidance information F are displayed at different positions of the chat message display area 302 as prompt information. As shown in FIG. 3B, an interactive interface 301 corresponding to a target chat is displayed on a client display interface 30, and the interactive interface 301 includes a chat message display area 302, a chat information display area 303 and a chat message input area 304; where the interactive interface 301 is understood as a display area composed of the chat message display area 302, the chat information display area 303 and the chat message input area 304. In the chat message display area 302, a guide control A, a guide control B and a guide control C are displayed. The guide control A, the guide control B and the guide control C are displayed in cards. Moreover, in the chat message display area 302, guidance information A corresponding to the guide control A, guidance information B corresponding to the guide control B, and guidance control C corresponding to the guide control C, as well as guidance information D and guidance information F are further displayed; and the guidance information D and the guidance information F are displayed at different positions of the chat message display area 302 as prompt information.
Step 102, performing a processing operation corresponding to the trigger operation in response to receipt of the trigger operation for a target guide control of the at least one guide control.

Based on the introduction in Step 101, the at least one guide control corresponds to an information processing function of the target chat. Thus, the user may perform the information processing operation through the trigger operation for the corresponding guide control.

Therefore, in Step 102, when the user initiates the trigger operation for the target guide control of the at least one guide control, the processing operation corresponding to the trigger operation is performed.

In some embodiments, if the target guide control is configured with a usage permission, the corresponding processing operation may be to display prompt information indicating no operation permission.

In some other embodiments, in conjunction with different target guide controls, the processing operations corresponding to the trigger operations also differ accordingly. Next, some possible implementations will be introduced.

As an optional implementation, the target guide control includes a control for inviting a member to join the chat. At this time, performing the processing operation corresponding to the trigger operation includes:
displaying a configuration interface corresponding to the control for inviting a member to join the chat. The configuration interface includes: identification information of the target chat and a share control corresponding to the identification information of the target chat.

In some embodiments, the configuration interface corresponding to the control for inviting a member to join the chat may be displayed in a part of a current display interface, which may block a message display area of the target chat, or may be displayed side by side with the message display area of the target chat.

In some embodiments, the identification information of the target chat may be: a join link of the target chat, a two-dimensional code of the target chat, etc.

In response to a trigger operation for the share control, displaying a sharing interface, where the sharing interface includes: selection controls corresponding to multiple sharing objects respectively.

In some other embodiments, the sharing interface may also exclude the selection controls corresponding to the sharing objects, and the user may select the sharing objects by clicking display positions where the sharing objects are located.

In some embodiments, the sharing object may be embodied in the form of a sharing object group, for example, the sharing object group includes: an external contact, a managed chat, etc.; the group of external contact includes multiple external contacts; and the group of managed chat includes multiple chats. Therefore, the sharing object may be a chat, a contact including an external contact and an internal contact, etc.

In response to a trigger operation for a target selection control, sending the identification information of the target chat to a sharing object corresponding to the target selection control, so that the sharing object corresponding to the target selection control joins the target chat based on the identification information of the target chat.

In some embodiments, if the identification information of the target chat is the join link of the target chat, the sharing object may join the target chat by opening the join link. If the identification information of the target chat is the two-dimensional code of the target chat, the sharing object may join the target chat by scanning the two-dimensional code.

In this implementation, through the control for inviting a member to join the chat, the user may quickly and conveniently invite a new member to join the target chat, thereby improving the flexibility and convenience of interaction, and improving the user's interaction experience.

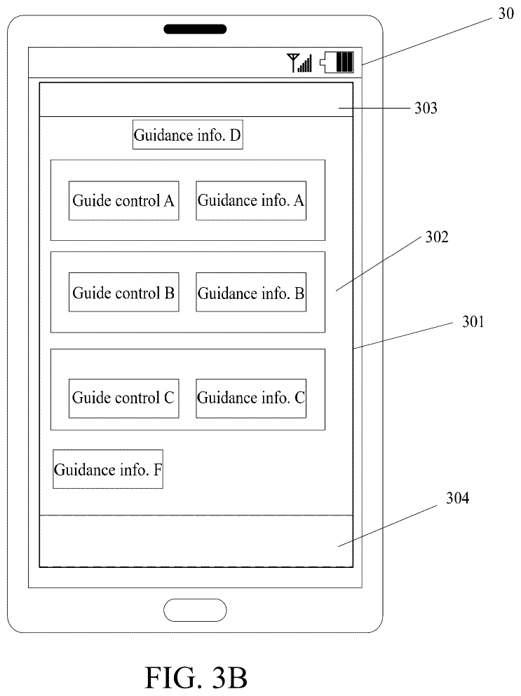

As shown in FIG. 4A, a configuration interface 401 corresponding to a control for inviting a member to join a chat is displayed on a client display interface 40, and identification information 402 of the target chat and a share control 403 corresponding to the identification information of the target chat are displayed in the configuration interface 401. After the user initiates a trigger operation for the share control 403, as shown in FIG. 4B, a sharing interface 404 is displayed on the client display interface 40, and the sharing interface 404 includes a sharing object A, a sharing object B, and a sharing object C. The sharing object A, the sharing object B, and the sharing object C may be a contact, a chat, or a group corresponding to multiple sharing objects.

As an optional implementation, the target guide control includes a control for perfecting chat information, and performing the processing operation corresponding to the trigger operation includes: displaying a configuration interface corresponding to the control for perfecting chat information, where the configuration interface includes: an avatar configuration control, a chat name configuration control, and a chat description configuration control.

In some embodiments, the configuration interface corresponding to the control for perfecting chat information may be displayed in a part of a current display interface, which may block a message display area of the target chat, or may be displayed side by side with the message display area of the target chat.

Through the avatar configuration control, the user may configure an avatar of the target chat. In some embodiments, the user may upload a favorite avatar as the avatar of the target chat. In some other embodiments, the user may select a favorite avatar from avatars provided by the chat application as the avatar of the target chat.

Through the chat name configuration control, the user may configure a name of the target chat. In some embodiments, the user may input the name of the target chat through a chat name input box. In some other embodiments, the user may implement input of the name of the target chat through functions such as “paste”.

Through the chat description configuration control, the user may configure a description of the chat. In some embodiments, the user may input description information of the target chat through a description information input box. In some other embodiments, the user may implement input of the description information of the target chat through functions such as “paste”.

In this implementation, through the control for perfecting chat information, the user may quickly edit (perfect) chat information, thereby improving the efficiency and convenience of interaction, and improving the user's interaction experience.

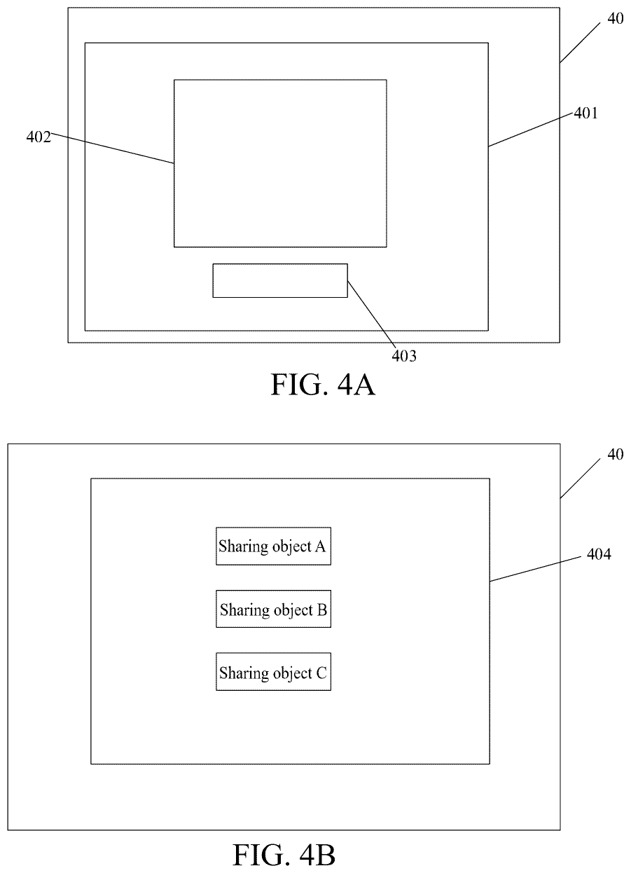

As shown in FIG. 5, an interactive interface 501 corresponding to a target chat is displayed on a client display interface 50, and the interactive interface 501 includes a chat message display area 502, a chat information display area 503 and a chat message input area 504; where the interactive interface 502 is understood as a display area composed of the chat message display area 502, the chat information display area 503 and the chat message input area 504. In the chat message display area 502, a configuration interface 505 corresponding to a control for perfecting chat information is displayed, and the configuration interface includes: an avatar configuration control 506, a chat name configuration control 507, and a chat description configuration control 508.

As an optional implementation, the target guide control includes a control for perfecting a chat announcement, and performing the processing operation corresponding to the trigger operation includes: displaying a configuration interface corresponding to the control for perfecting a chat announcement, where the configuration interface includes: an edit page and selection controls corresponding to multiple announcement templates respectively; and in response to a trigger operation for a target selection control, displaying an announcement template corresponding to the target selection control in the edit page.

In some embodiments, the configuration interface corresponding to the control for perfecting a chat announcement may be displayed in a part of a current display interface, which may block a message display area of the target chat, or may be displayed side by side with the message display area of the target chat.

In some embodiments, the configuration interface may also exclude the announcement template, that is, the configuration interface does not include a selection function of the announcement template, and the user may edit it by himself/herself.

In some embodiments, the multiple announcement templates may not be configured with corresponding selection controls, and the user may select a corresponding announcement template by clicking display positions of identification information of the multiple announcement templates.

In some other embodiments, in addition to the edit page and the selection controls corresponding to the announcement templates, the configuration interface may also include an edit complete control. By triggering the edit complete control, the editing of the announcement may be completed.

In this implementation, through the control for perfecting a chat announcement, the user may quickly edit or select a chat announcement, thereby improving the efficiency and convenience of interaction, and improving the user's interaction experience.

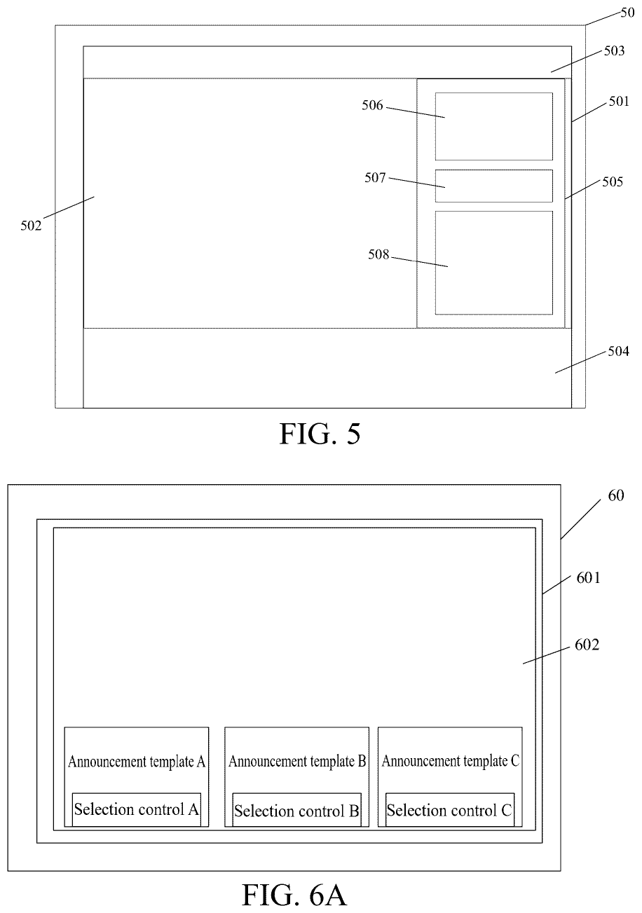

As shown in FIG. 6A, a configuration interface 601 corresponding to a control for perfecting a chat announcement is displayed on a client display interface 60, and an edit page 602, a selection control A corresponding to an announcement template A, a selection control B corresponding to an announcement template B, and a selection control C corresponding to an announcement template C are displayed in the configuration interface 601; the user may initiate a trigger operation for a corresponding selection control to display a corresponding announcement template, and then edit based on the announcement template; after the editing is completed, the announcement may be published. For example, the user initiates a trigger operation for the selection control A, and then the announcement template A is displayed. As shown in FIG. 6B, a configuration interface 601 corresponding to a control for perfecting a chat announcement is displayed on a client display interface 60, and an edit page 602 and an edit complete control 603 are displayed in the configuration interface 601; where the configuration interface 601 occupies the entire display area or a part of the display area of the client display interface 60. After the user inputs corresponding announcement content in the edit page 602, the user initiates a trigger operation for the edit complete control 603, and then the editing and publishing of the announcement may be completed.

As an optional implementation, the target guide control includes a control for configuring a chat label, and performing the processing operation corresponding to the trigger operation includes: displaying a configuration interface corresponding to the control for configuring a chat label, where the configuration interface includes: a label add control; and in response to a trigger operation for the label add control, displaying an added label at a preset position of the interactive interface, where the added label is used to access a target document or a target link.

In some embodiments, the configuration interface corresponding to the control for configuring a chat label may be displayed in a part of a current display interface, which may block a message display area of the target chat, or may be displayed side by side with the message display area of the target chat.

In some embodiments, in addition to the label add control, the configuration interface further includes a setting or selection control for the label.

In some embodiments, if the content of the label is the target link, the configuration interface includes: an input box of the target link, and an input box of a name of the target link. The content input in the two input boxes may be implemented through a “paste”function.

In some embodiments, if the content of the label is the target document or the target link, the configuration interface includes a document list, and the document list includes at least one selectable document, and a target link input box. The user may select the target document by viewing the document list and clicking a display position of the document. The user may also input the target link in the target link input box to implement addition of the target link.

In some embodiments, the preset position of the interactive interface may be a corresponding position in a target chat information display page. The target chat information display page may be displayed directly based on the interactive interface, or may be displayed based on a trigger operation for a control in the interactive interface.

In this implementation, by adding the target document or the target link as the label content, members in the target chat may quickly access the target document or the target link through the added label, thereby improving the convenience of interaction, and improving the user's interaction experience.

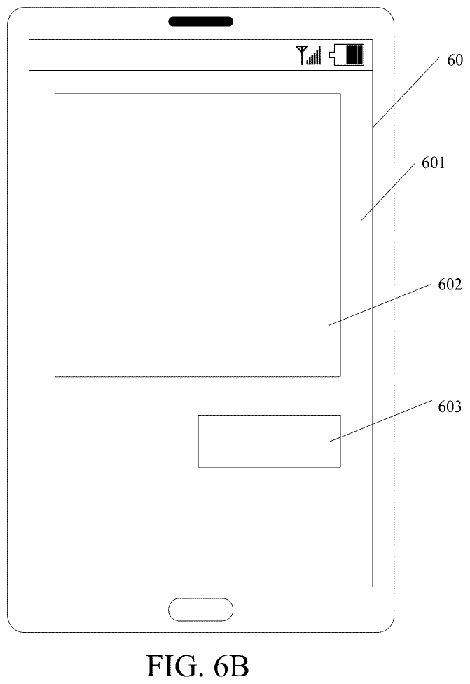

As shown in FIG. 7A, a configuration interface 701 corresponding to a control for configuring a chat label is displayed on a client display interface 70, and the configuration interface 701 includes a label add control 702, a label content input box 703 and a label name input box 704. The user may input label content in the label content input box 703 and input a label name in the label name input box 704. As shown in FIG. 7B, a configuration interface 701 corresponding to a control for configuring a chat label is displayed on a client display interface 70; where the configuration interface 701 occupies the entire display area or a part of the display area of the client display interface 70. The configuration interface 701 includes a label add control 702, a label content input box 703 and a document list 705, and the document list 705 includes at least one document. The user may input the label content through the label content input box 703, or may select the target document through the document list 705.

In some embodiments, the processing operation corresponding to the trigger operation may also be a specific configuration operation, and the configuration is not necessarily performed after the corresponding configuration interface is displayed.

In some embodiments, assuming that the target chat is a public group chat, e.g., an all-member group of an enterprise, the at least one guide control includes: a control for inviting a member to join the chat, a control for perfecting chat information, and a control for perfecting a chat announcement.

In some other embodiments, assuming that the target chat is a private group chat, e.g., a department group of an enterprise, the at least one guide control includes: a control for perfecting chat information, a control for perfecting a chat announcement, and a control for configuring a chat label.

Through the introduction of the implementations of the present disclosure, in the information processing solution provided by the embodiments of the present disclosure, the interactive interface corresponding to the target chat is displayed in response to receipt of the preset operation instruction for the target chat, where the at least one guide control is displayed in the interactive interface; and the processing operation corresponding to the trigger operation is performed in response to receipt of the trigger operation for the target guide control of the at least one guide control. Therefore, for the user, after the preset operation instruction is issued, the corresponding processing operation may be initiated through the trigger operation for the at least one guide control. In one aspect, the at least one guide control serves as a guide and reminder, so as to assist the user in better processing and using the related information. In another aspect, the processing operation corresponding to the trigger operation may be performed through the trigger operation for the at least one guide control, so as to achieve a rapid response to the user's needs. Thus, the technical solution may not only assist the user in better processing and using information, but also quickly respond to the user's needs for processing and use, thereby improving the user's interaction experience.

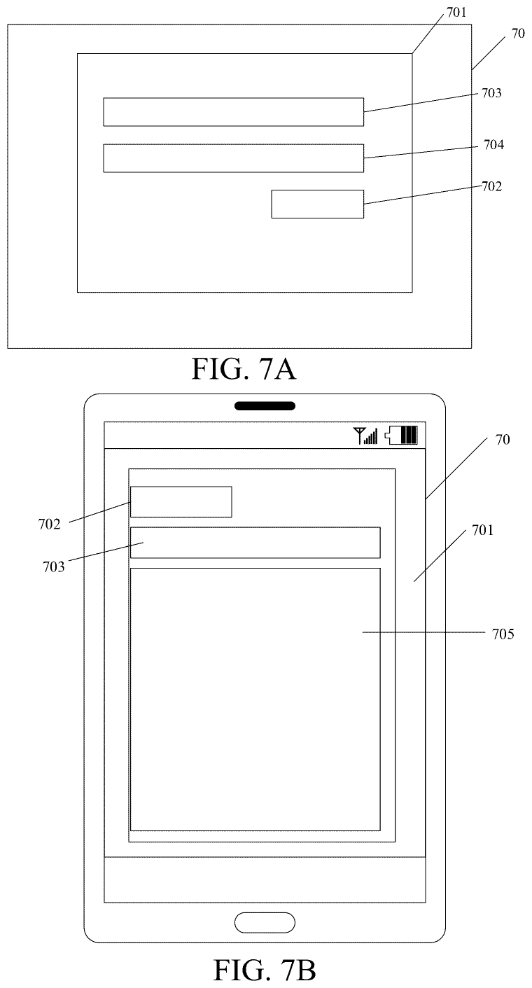

Further referring to FIG. 8, as an implementation of the method shown in the above figures, the present disclosure provides an embodiment of an information processing apparatus. This apparatus embodiment corresponds to the embodiment of the information processing method shown in FIG. 1, and the apparatus may be specifically applied to various electronic devices.

As shown in FIG. 8, the information processing apparatus in this embodiment includes: a displaying unit 801 configured to display an interactive interface corresponding to a target chat in response to receipt of a preset operation instruction for the target chat, wherein at least one guide control is displayed in the interactive interface; and a processing unit 802 configured to perform a processing operation corresponding to a trigger operation in response to receipt of the trigger operation for a target guide control of the at least one guide control.

In some embodiments, the type of guide control is related to a chat type of the target chat.

In some embodiments, the type of guide control is further related to a role played by the user to which the interactive interface belongs in the target chat.

In some embodiments, the displaying at least one guide control in the interactive interface includes: displaying the at least one guide control in a chat message display area of the interactive interface.

In some embodiments, the preset operation instruction includes: a creation operation instruction for the target chat; and a chat type conversion operation instruction for the target chat.

In some embodiments, the displaying unit 801 is further configured to: display the interactive interface corresponding to the target chat according to at least one guide control corresponding to the target chat delivered by a server.

In some embodiments, the server delivers the at least one guide control corresponding to the target chat according to the chat type of the target chat and/or the role played by the user to which the interactive interface belongs in the target chat.

In some embodiments, the target guide control includes a control for inviting a member to join the chat, and the displaying unit 801 is further configured to: display a configuration interface corresponding to the control for inviting a member to join the chat, wherein the configuration interface includes: identification information of the target chat and a share control corresponding to the identification information of the target chat; and in response to a trigger operation for the share control, display a sharing interface, wherein the sharing interface includes: selection controls corresponding to multiple sharing objects respectively. The processing unit 802 is further configured to: in response to a trigger operation for a target selection control, send the identification information of the target chat to a sharing object corresponding to the target selection control, so that the sharing object corresponding to the target selection control joins the target chat based on the identification information of the target chat.

In some embodiments, the target guide control includes a control for perfecting chat information, and the displaying unit 801 is further configured to: display a configuration interface corresponding to the control for perfecting chat information, wherein the configuration interface includes: an avatar configuration control, a chat name configuration control, and a chat description configuration control.

In some embodiments, the target guide control includes a control for perfecting a chat announcement, and the displaying unit 801 is further configured to: display a configuration interface corresponding to the control for perfecting a chat announcement, wherein the configuration interface includes: an edit page and selection controls corresponding to multiple announcement templates respectively. The processing unit 802 is further configured to: in response to a trigger operation for a target selection control, display an announcement template corresponding to the target selection control in the edit page.

In some embodiments, the target guide control includes a control for configuring a chat label, and the displaying unit 801 is further configured to: display a configuration interface corresponding to the control for configuring a chat label, wherein the configuration interface includes: a label add control. The processing unit 802 is further configured to: in response to a trigger operation for the label add control, display an added label at a preset position of the interactive interface, wherein the added label is used to access a target document or a target link.

In some embodiments, at least one piece of guidance information is further displayed in the interactive interface, and the guidance information is related to a chat type of the target chat.

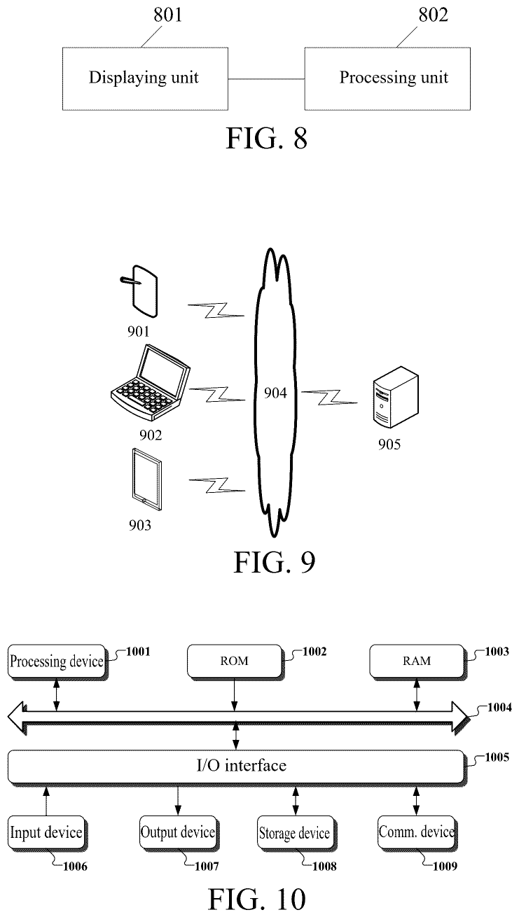

Referring to FIG. 9, it shows an exemplary system architecture to which an embodiment of an information processing method according to the present disclosure may be applied.

As shown in FIG. 9, the system architecture may include terminal devices 901, 902, 903, a network 904, and a server 905. The network 904 may be a medium for providing communication links between the terminal devices 901, 902, 903 and the server 905. The network 904 may include various connection types, such as wired, wireless communication links or fiber optic cables, and so on.

The terminal devices 901, 902, 903 may interact with the server 905 through the network 904 to receive or send messages, and the like. Various client applications may be installed on the terminal devices 901, 902, 903, such as a web browser application, a search application, a news application, and the like. The client application in the terminal devices 901, 902, 903 may receive instructions from a user and perform corresponding functions according to the instructions from the user, such as adding corresponding information into information according to the instructions from the user.

The terminal devices 901, 902, 903 may be hardware or software. When the terminal devices 901, 902, 903 are hardware, they may be various electronic devices with a display screen and supporting webpage browsing, including but not limited to a smart phone, a tablet computer, an e-book reader, an MP3 (Moving Picture Experts Group Audio Layer III) player, an MP4 (Moving Picture Experts Group Audio Layer IV) player, a laptop computer, a desktop computer, and the like. When the terminal devices 901, 902, 903 are software, they may be installed in the above-listed electronic devices. They may be implemented as multiple software or software modules (for example, software or software modules for providing distributed services), or may be implemented as a single software or software module. This is not specifically limited herein.

The server 905 may be a server that provides various services, for example, receiving information acquisition requests sent by the terminal devices 901, 902, 903, and acquiring display information corresponding to the information acquisition requests in various manners according to the information acquisition requests. And it sends the related data of the displayed information to the terminal devices 901, 902, 903.

It should be noted that the information processing method provided by the embodiments of the present disclosure may be executed by the terminal device, and accordingly, the information processing apparatus may be provided in the terminal devices 901, 902, 903. In addition, the information processing method provided by the embodiments of the present disclosure may also be executed by the server 905, and accordingly, the information processing apparatus may be provided in the server 905.

It should be understood that the number of terminal devices, networks, and servers in FIG. 9 is only schematic. According to implementation requirements, any number of terminal devices, networks, and servers may be provided.

Referring to FIG. 10 below, it shows a schematic structural diagram of an electronic device (such as the terminal device or server in FIG. 9) suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a tablet computer (PAD), a portable multimedia player (PMP), a vehicle-mounted terminal (such as a vehicle navigation terminal), and a fixed terminal such as a digital TV, a desktop computer, and the like. The electronic device shown in FIG. 10 is only an example, and should not bring any limitation to the function and the scope of use of the embodiments of the present disclosure.

As shown in FIG. 10, the electronic device may include a processing device (e.g., a central processing unit, a graphics processing unit, etc.) 1001, which may perform a variety of appropriate actions and processing in accordance with a program stored in a read-only memory (ROM) 1002 or a program loaded from a storage device 1008 into a random-access memory (RAM) 1003. The RAM 1003 further stores various programs and data required for the operation of the electronic device 600. The processing device 1001, the ROM 1002, and the RAM 1003 are connected to each other through a bus 1004. An input/output (I/O) interface 1005 is also connected to the bus 1004.

Generally, the following devices may be connected to the I/O interface 1005: an input device 1006 including, for example, a touchscreen, a touchpad, a keyboard, a mouse, a camera, a microphone, an accelerometer, a gyroscope, or the like; an output device 1007 including, for example, a liquid crystal display (LCD), a speaker, a vibrator, or the like; a storage device 1008 including, for example, a magnetic tape, a hard disk, or the like; and a communication device 1009. The communication device 1009 may allow the electronic device to perform wireless or wired communication with other devices to exchange data. Although FIG. 10 shows an electronic device having various devices, it should be understood that it is not required to implement or have all of the illustrated devices. More or fewer devices may alternatively be implemented or provided.

In particular, according to an embodiment of the present disclosure, the processes described above with reference to the flowcharts may be implemented as a computer software program. For example, an embodiment of the present disclosure includes a computer program product, which includes a computer program carried on a non-transitory computer-readable medium, where the computer program includes program codes for executing the method shown in the flowchart. In such an embodiment, the computer program may be downloaded and installed from a network through the communication device 1009, or installed from the storage device 1008, or installed from the ROM 1002. When the computer program is executed by the processing device 1001, the above-mentioned functions defined in the method of the embodiment of the present disclosure are executed.

It should be noted that the above-mentioned computer-readable medium in the present disclosure may be a computer-readable signal medium or a computer-readable storage medium, or any combination of the above two. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program that can be used by or in combination with an instruction execution system, apparatus, or device. In the present disclosure, the computer-readable signal medium may include a data signal propagated in a baseband or as a part of a carrier, in which a computer-readable program codes are carried. Such a propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium may be transmitted by any suitable medium, including but not limited to: wire, optical cable, RF (Radio Frequency), etc., or any suitable combination thereof.

In some implementations, the client and the server may communicate using any currently known or future-developed network protocol, such as the Hypertext Transfer Protocol (HTTP), and may be interconnected with digital data communication (for example, a communication network) in any form or medium. Examples of communication networks include a local area network (“LAN”), a wide area network (“WAN”), an internetwork (for example, the Internet), and a peer-to-peer network (for example, an ad hoc network), as well as any currently known or future-developed networks.

The above-mentioned computer-readable medium may be included in the above-mentioned electronic device, or may exist alone without being assembled into the electronic device.

The above-mentioned computer-readable medium carries one or more programs that, when executed by the electronic device, cause the electronic device to: display an interactive interface corresponding to a target chat in response to receipt of a preset operation instruction for the target chat, where at least one guide control is displayed in the interactive interface; and perform a processing operation corresponding to a trigger operation in response to receipt of the trigger operation for a target guide control of the at least one guide control.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the case of a remote computer, the remote computer may be connected to the user's computer through any kind of network, including a local area network (LAN) or a wide area network (WAN), or may be connected to an external computer (for example, via the Internet using an Internet service provider).

The flowcharts and block diagrams in the drawings illustrate the architecture, functions, and operations of possible implementations of systems, methods, and computer program products according to various embodiments of the present disclosure. In this regard, each block in the flowcharts or block diagrams may represent a module, a program segment, or a portion of codes that contains one or more executable instructions for implementing specified logical functions. It should also be noted that, in some alternative implementations, the functions noted in the blocks may also occur in a different order than the order noted in the drawings. For example, two blocks shown in succession may, in fact, be executed substantially concurrently, or the blocks may sometimes be executed in the reverse order, depending upon the functionality involved. It should also be noted that each block of the block diagrams and/or flowcharts, and combinations of blocks in the block diagrams and/or flowcharts, may be implemented by a dedicated hardware-based system that performs specified functions or operations, or may be implemented by a combination of dedicated hardware and computer instructions.

The units involved in the embodiments of the present disclosure may be implemented by software or hardware. The name of a unit does not constitute a limitation on the unit itself in some cases. For example, the displaying unit 801 may also be described as “a unit for displaying an interactive interface corresponding to a target chat”.

The functions described herein above may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an illustration of the applied technical principles. Those skilled in the art should understand that the disclosure scope involved in the present disclosure is not limited to the technical solutions formed by the specific combination of the above technical features, but also covers other technical solutions formed by any combination of the above technical features or their equivalent features without departing from the above disclosed concept. For example, a technical solution formed by replacing the above features with technical features with similar functions disclosed in the present disclosure (but not limited to this).

In addition, although the operations are depicted in a specific order, this should not be understood as requiring these operations to be performed in a specific order shown or in a sequential order. Under certain circumstances, multitasking and parallel processing may be advantageous. Similarly, although several specific implementation details are included in the above discussion, these should not be interpreted as limiting the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the methods, it should be understood that the subject matter defined in the appended claims is not necessarily limited to the specific features or actions described above. On the contrary, the specific features and actions described above are only exemplary forms for implementing the claims.

1. An information processing method, comprising:
displaying an interactive interface corresponding to a target chat in response to receipt of a preset operation instruction for the target chat, wherein at least one guide control is displayed in the interactive interface; and
performing a processing operation corresponding to a trigger operation in response to receipt of the trigger operation for a target guide control of the at least one guide control.

2. The information processing method according to claim 1, wherein,
a type of the guide control is related to a chat type of the target chat.

3. The information processing method according to claim 2, wherein,
the type of the guide control is further related to a role played by a user to which the interactive interface belongs in the target chat.

4. The information processing method according to claim 1, wherein the displaying at least one guide control in the interactive interface comprises: displaying the at least one guide control in a chat message display area of the interactive interface.

5. The information processing method according to claim 1, wherein the preset operation instruction comprises: a creation operation instruction for the target chat; and a chat type conversion operation instruction for the target chat.

6. The information processing method according to claim 1, wherein the displaying the interactive interface corresponding to the target chat comprises:
displaying the interactive interface corresponding to the target chat according to at least one guide control corresponding to the target chat delivered by a server.

7. The information processing method according to claim 6, wherein the server delivers the at least one guide control corresponding to the target chat according to at least one of a chat type of the target chat or a role played by a user to which the interactive interface belongs in the target chat.

8. The information processing method according to claim 1, wherein the target guide control comprises a control for inviting a member to join the chat, and the performing the processing operation corresponding to the trigger operation comprises:
displaying a configuration interface corresponding to the control for inviting the member to join the chat, wherein the configuration interface comprises: identification information of the target chat and a share control corresponding to the identification information of the target chat;
in response to a trigger operation for the share control, displaying a sharing interface, wherein the sharing interface comprises: selection controls corresponding to multiple sharing objects respectively; and
in response to a trigger operation for a target selection control, sending the identification information of the target chat to a sharing object corresponding to the target selection control, so that the sharing object corresponding to the target selection control joins the target chat based on the identification information of the target chat.

9. The information processing method according to claim 1, wherein the target guide control comprises a control for perfecting chat information, and the performing a processing operation corresponding to a trigger operation comprises:
displaying a configuration interface corresponding to the control for perfecting chat information, wherein the configuration interface comprises: an avatar configuration control, a chat name configuration control, and a chat description configuration control.

10. The information processing method according to claim 1, wherein the target guide control comprises a control for perfecting a chat announcement, and the performing the processing operation corresponding to the trigger operation comprises:
displaying a configuration interface corresponding to the control for perfecting the chat announcement, wherein the configuration interface comprises: an edit page and selection controls corresponding to multiple announcement templates respectively; and
in response to a trigger operation for a target selection control, displaying an announcement template corresponding to the target selection control in the edit page.

11. The information processing method according to claim 1, wherein the target guide control comprises a control for configuring a chat label, and the performing the processing operation corresponding to the trigger operation comprises:
displaying a configuration interface corresponding to the control for configuring the chat label, wherein the configuration interface comprises: a label add control; and
in response to a trigger operation for the label add control, displaying an added label at a preset position of the interactive interface, wherein the added label is used to access a target document or a target link.

12. The information processing method according to claim 1, wherein at least one piece of guidance information is further displayed in the interactive interface, and the guidance information is related to a chat type of the target chat.

13. (canceled)

14. An electronic device, comprising:
one or more processors; and
a storage configured to store one or more programs,
wherein the one or more programs, when executed by the one or more processors, cause the one or more processors to implement information processing operations comprising:
displaying an interactive interface corresponding to a target chat in response to receipt of a preset operation instruction for the target chat, wherein at least one guide control is displayed in the interactive interface; and
performing a processing operation corresponding to a trigger operation in response to receipt of the trigger operation for a target guide control of the at least one guide control.

15. A non-transitory computer-readable storage medium having a computer program stored thereon, wherein the computer program, when executed by a processor, implements information processing operations comprising:
displaying an interactive interface corresponding to a target chat in response to receipt of a preset operation instruction for the target chat, wherein at least one guide control is displayed in the interactive interface; and
performing a processing operation corresponding to a trigger operation in response to receipt of the trigger operation for a target guide control of the at least one guide control.

16. (canceled)

17. The electronic device according to claim 14, wherein,
a type of the guide control is related to a chat type of the target chat.

18. The electronic device according to claim 17, wherein,
the type of the guide control is further related to a role played by a user to which the interactive interface belongs in the target chat.

19. The electronic device according to claim 14, wherein the displaying at least one guide control in the interactive interface comprises: displaying the at least one guide control in a chat message display area of the interactive interface.

20. The storage medium according to claim 15, wherein,
a type of the guide control is related to a chat type of the target chat.

21. The storage medium according to claim 20, wherein,
the type of the guide control is further related to a role played by a user to which the interactive interface belongs in the target chat.

22. The storage medium according to claim 15, wherein the displaying at least one guide control in the interactive interface comprises: displaying the at least one guide control in a chat message display area of the interactive interface.
